(19) United States
(12) Patent Application Publication
(10) Pub. No.: US 2018/0144622 A1
(43) Pub. Date: May 24, 2018

(54) Parking Notification Systems And Methods For Identifying Locations Of Vehicles

(71) Applicant: Toyota Motor Engineering & Manufacturing North America, Inc., Erlanger, KY (US)

(72) Inventors: Sergei Gage, Redford, MI (US); Nicholas S. Sitarski, Ypsilanti, MI (US); Ida T. Mai-Krist, White Lake, MI (US)

(73) Assignee: Toyota Motor Engineering & Manufacturing North America,Inc., Erlanger, KY (US)

(21) Appl. No.: 15/423,793

(22) Filed: Feb. 3, 2017

Related U.S. Application Data
(60) Provisional application No. 62/423,853, filed on Nov. 18, 2016.

(51) Int. Cl. G08G 1/017; G08G 1/054; G08G 1/133; G01S 19/14; H04N 7/18; G06K 9/00; G06K 9/46; H04N 1/00

(52) U.S. Cl. CPC G08G 1/0175; G08G 1/054; G08G 1/133; G01S 19/14; H04N 7/188; H04L 51/24; G06K 9/4671; H04N 1/00103; H04N 1/00122; G06K 2209/01; G06K 2209/27; G06K 9/00818

(57) ABSTRACT

A parking notification system for identifying a location of a vehicle includes a controller, a processor, a non-transitory computer readable memory, a camera, and a machine-readable instruction set. The controller includes the processor and the non-transitory computer readable memory. The camera is communicatively coupled to the controller, where the camera automatically captures image data and transmits the image data to the controller. The machine-readable instruction set is stored in the non-transitory computer readable memory and causes the processor to determine when the vehicle enters a parking area, activate the camera in response to determining that the vehicle has entered the parking area, receive the image data from the camera once activated, determine when the vehicle is parked, determine parking information from the image data, and transmit the parking information automatically to an output of the controller in response to determining that the vehicle is parked.

### CROSS-REFERENCE TO RELATED APPLICATION

This application claims the benefit of U.S. Provisional Application No. 62/423,853, entitled “PARKING NOTIFICATION SYSTEMS AND METHODS FOR IDENTIFYING LOCATIONS OF VEHICLES,” filed Nov. 18, 2016, the entirety of which is hereby incorporated by reference.

### TECHNICAL FIELD

The present specification generally relates to parking notification systems and methods and, more specifically, parking notification systems and methods for automatically determining parking locations of vehicles and automatically providing parking information.

### BACKGROUND

Locating a vehicle several hours, or even minutes, after parking can be a frustrating and time-consuming task. This usually happens when a vehicle is parked in a large parking structure or at an unfamiliar location. To avoid this issue, many parking lots and parking structures issue parking tickets identifying the parking structure and fields to fill in more specific information, such as, a parking level and a parking space number. Some parking locations even offer preprinted cards with the parking level identified on them at the exits. However, this requires the driver to remember to enter the parking information. Failing to remember to record the parking information renders these parking location reminders useless. It is especially challenging to remember to record vehicle parking information when a driver's mind is focused on upcoming events, for example, making a dinner reservation, getting the family together for a baseball game, recalling a grocery list as you arrive at the grocery store, or catching a shuttle to the airport terminal.

Accordingly, a need exists for alternative systems and methods for automatically determining parking locations of vehicles and automatically providing the parking location.

### SUMMARY

In one embodiment, a parking notification system for identifying a location of a vehicle includes a controller, a processor, a non-transitory computer readable memory, a camera, and a machine-readable instruction set. The controller includes the processor and non-transitory computer readable memory. The camera may be communicatively coupled to the controller where the camera automatically captures image data and transmits the image data to the controller. The machine-readable instruction set may be stored in the non-transitory computer readable memory and may cause the processor to determine when the vehicle enters a parking area, activate the camera in response to determining that the vehicle has entered the parking area, receive the image data from the camera once activated, determine when the vehicle is parked, determine parking information from the image data, and transmit the parking information automatically to an output of the controller in response to determining that the vehicle is parked.

In another embodiment, a method for locating a parked vehicle includes determining a vehicle entered a parking area, activating a camera in response to determining that the vehicle has entered the parking area, receiving image data from the camera once activated, determining parking information from the image data, determining when the vehicle is parked, and transmitting the parking information automatically in response to determining that the vehicle is parked.

In yet another embodiment, a parking notification system for identifying a location of a vehicle includes a controller, a processor, a non-transitory computer readable memory, a camera, a global positioning system, a wireless communication module, an occupant sensor, and a machine-readable instruction set. The controller includes the processor and the non-transitory computer readable memory. The camera may be communicatively coupled to the controller where the camera is configured to capture image data and transmit the image data to the controller. The global positioning system may be communicatively coupled to the controller where the global positioning system provides location information to the controller. The wireless communication module may be configured to wirelessly transmit the parking information where the wireless communication module is communicatively coupled to the processor. The occupant sensor may be communicatively coupled to the controller where the occupant sensor provides an occupant sensor signal indicative of a presence or an absence of a driver to the processor. The machine-readable instruction set may be stored in the non-transitory computer readable memory and may cause the processor to determine when the vehicle enters a parking area based at least in part on the location information, activate the camera in response to determining that the vehicle has entered the parking area, receive the image data from the camera once activated, determine when the vehicle is parked based on at least one of image data captured by the camera and location information provided by the global positioning system, determine parking information from the image data, determine the presence of the driver in the vehicle based on the occupant sensor signal, and transmit the parking information with the wireless communication module in response to the occupant sensor signal.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a diagram of a parking notification system associated with a vehicle parked in a parking location according to one or more embodiments shown and described herein;

FIG. 2 schematically depicts components of a parking notification system according to one or more embodiments shown and described herein;

FIG. 3 is a flowchart depicting a method of identifying the location of a vehicle according to one or more embodiments shown and described herein;

FIG. 4 is an example display of parking information generated by the parking notification system according to one or more embodiments shown and described herein; and

FIG. 5 is a flowchart depicting an image processing method of the parking notification system according to one or more embodiments shown and described herein.

### DETAILED DESCRIPTION

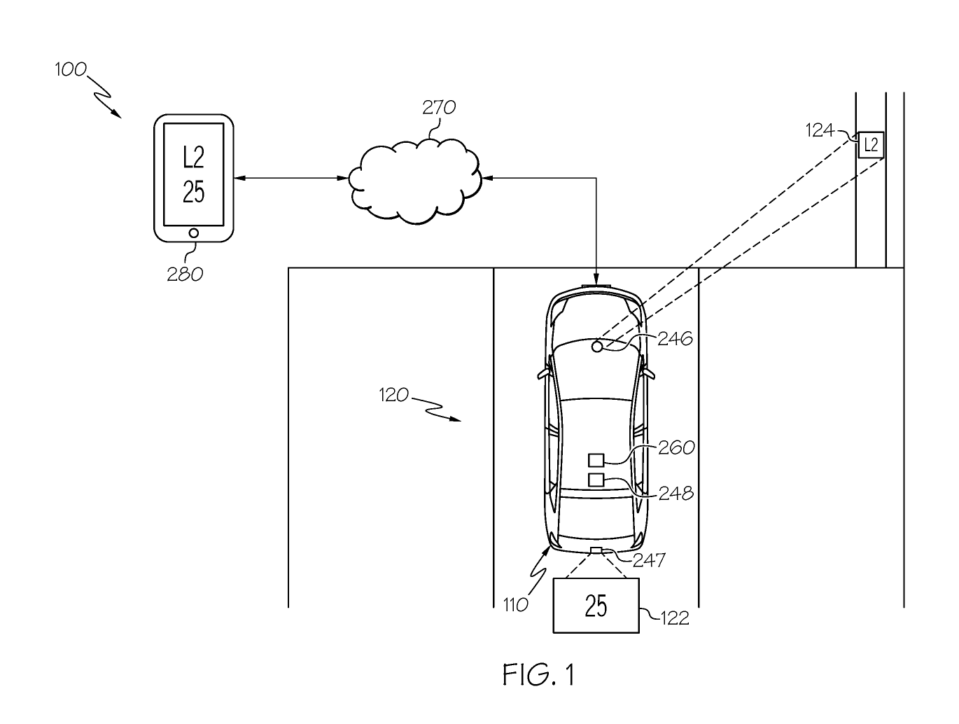

FIG. 1 generally depicts one embodiment of a vehicle parking notification system for automatically determining a parking location of a vehicle and automatically providing the parking location of the vehicle. The parking notification system automatically determines the parking location of the vehicle from a communicatively coupled camera and/or global positioning system. The camera may provide image data including landmarks, street signs, parking structures, parking level identifiers and parking space markers, or the like to a controller that processes the image data for determining the vehicle parking location. Additionally, a global positioning system (GPS) may provide location information of the vehicle to the controller. The controller may determine the parking location from the location information of the GPS and the image data from the camera. The controller and the communicatively coupled network interface hardware communicate the parking information to the driver, for example, by way of a portable electronic device. Various embodiments of parking notification systems and methods of automatically determining and automatically communicating parking locations of vehicles will be described in more detail herein.

Referring to FIG. 1, a diagram of a parking notification system 100 for providing parking information associated with a vehicle 110 parked in a parking location 120 is depicted. In FIG. 1, the vehicle 110 is parked in the parking location 120. The parking notification system 100 generally includes a vehicle equipped with a global positioning system 248, network interface hardware 260, a first camera 246, and a second camera 247. The first camera 246 and second camera 247 may continuously monitor surroundings of the vehicle 110 (e.g., prior to the vehicle entering the parking location 120 or parking structure, while the vehicle maneuvers through and into a parking location 120 or parking structure, and while the vehicle idles in a parking space of the parking location 120 or parking structure). While the vehicle 110 is in operation, the cameras 246, 247 may continuously generate image data of the surroundings of the vehicle 110 and communicate the image data to a controller of the parking notification system 100. For example, in FIG. 1 the first camera 246 is shown capturing image data of the surroundings of the vehicle, which includes a view of the parking level indicator 124. Additionally, for example, a second camera 247 is also shown, capturing image data of the surroundings of the vehicle, which includes a view of the parking space marker 122. In this embodiment the first camera 246 and a second camera 247 are implemented to capture image data of the surroundings of the vehicle. However, in other embodiments only one or more cameras may be positioned on the vehicle to capture similar or more image data of the surroundings of the vehicle 110. Additionally, the global positioning system 248 may also provide location information to the controller for determining the location of the vehicle 110. The image data and location information may be used by the controller to determine the parking location 120 of the vehicle 110.

As will be explained in further detail below, the controller may analyze the image data and acquire parking information from the image data, for example, the parking level indicator 124 and the parking space marker 122. The controller may convert the parking information obtained from the image data to a user-friendly format for communication. In the embodiment depicted in FIG. 1, for example, the controller may determine the parking space is “25” and the parking level is “L2” from the image data. The controller of the parking notification system along with the network interface hardware 260 may automatically communicate the parking location 120 of the vehicle 110 to a network 270 and/or a personal electronic device 280. The automatic communication of the parking location 120 may occur upon the controller receiving a sensor signal indicative of a drive system of the vehicle being powered off, for example, or in response to one of several other events described herein. The network interface hardware 260 of the vehicle 110 is communicatively coupled to the network 270 and to the personal electronics device 280.

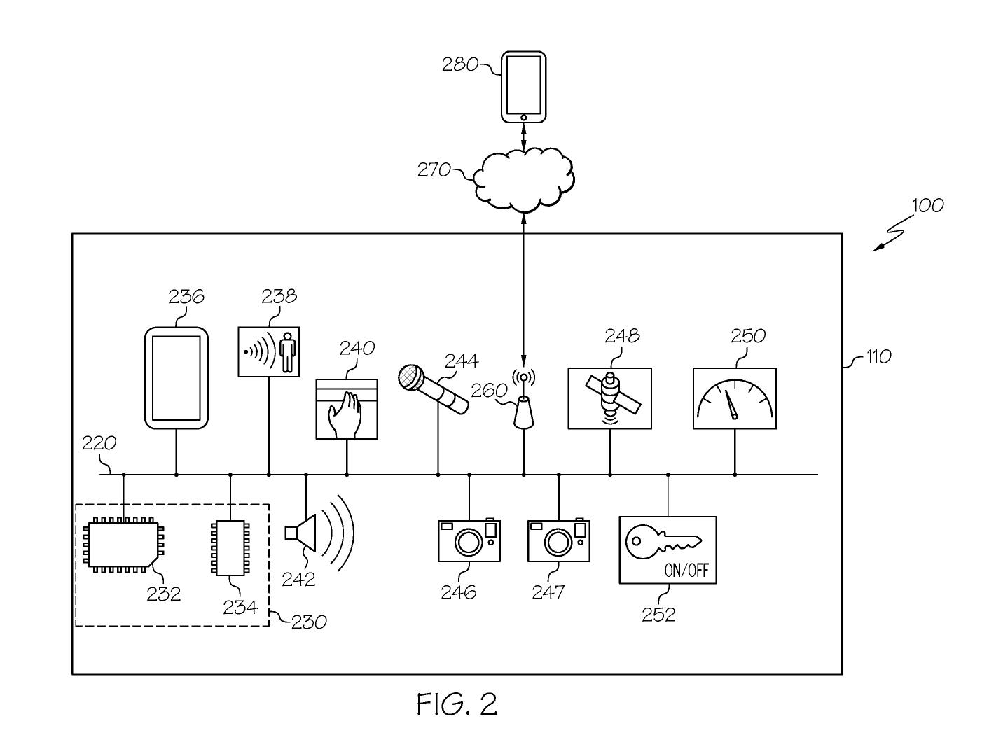

Referring now to FIG. 2, further components of the parking notification system 100 are schematically depicted. The parking notification system 100 for identifying the location of a vehicle 110 generally includes, a communication path 220, a controller 230 comprising a processor 232 and a non-transitory computer readable memory 234, a display 236, an occupant sensor 238, an input device 240, a speaker 242, a microphone 244, a first camera 246, a second camera 247, a global positioning system 248, a tachometer 250, an ignition sensor 252, and network interface hardware 260. The vehicle 110 is communicatively coupled to a network 270 and a portable electronic device 280 by way of the network hardware interface 260. The components of the parking notification system 100 may be contained within or mounted to a vehicle 110. The various components of the parking notification system 100 for identifying the location of a vehicle 110 and the interaction thereof will be described in detail below.

The communication path 220 may be formed from any medium that is capable of transmitting a signal such as, for example, conductive wires, conductive traces, optical waveguides, or the like. The communication path 220 may also refer to the expanse in which electromagnetic radiation and their corresponding electromagnetic waves traverse. Moreover, the communication path 220 may be formed from a combination of mediums capable of transmitting signals. In one embodiment, the communication path 220 comprises a combination of conductive traces, conductive wires, connectors, and buses that cooperate to permit the transmission of electrical data signals to components such as processors, memories, sensors, input devices, output devices, and communication devices. Accordingly, the communication path 220 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 220 communicatively couples the various components of the parking notification system 100. As used herein, the term “communicatively coupled” means that coupled components are capable of exchanging data signals with one another such as, for example, electrical signals via conductive medium, electromagnetic signals via air, optical signals via optical waveguides, and the like.

Still referring to FIG. 2, the controller 230 may be any device or combination of components comprising a processor 232 and non-transitory computer readable memory 234. The processor 232 of the parking notification system 100 may be any device capable of executing the machine-readable instruction set stored in the non-transitory computer readable memory 234. Accordingly, the processor 232 may be an electric controller, an integrated circuit, a microchip, a computer, or any other computing device. The processor 232 is communicatively coupled to the other components of the parking notification system 100 by the communication path 220. Accordingly, the communication path 220 may communicatively couple any number of processors 232 with one another, and allow the components coupled to the communication path 220 to operate in a distributed computing environment. Specifically, each of the components may operate as a node that may send and/or receive data. While the embodiment depicted in FIG. 2 includes a single processor 232, other embodiments may include more than one processor 232.

The non-transitory computer readable memory 234 of the parking notification system 100 is coupled to the communication path 220 and communicatively coupled to the processor 232. The non-transitory computer readable memory 234 may comprise RAM, ROM, flash memories, hard drives, or any non-transitory memory device capable of storing machine-readable instructions such that the machine-readable instructions can be accessed and executed by the processor 232. The machine-readable instruction set may comprise logic or algorithm(s) written in any programming language of any generation (e.g., 1GL, 2GL, 3GL, 4GL, or 5GL) such as, for example, machine language that may be directly executed by the processor 232, or assembly language, object-oriented programming (OOP), scripting languages, microcode, etc., that may be compiled or assembled into machine readable instructions and stored in the non-transitory computer readable memory 234. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 include a single non-transitory computer readable memory 234, other embodiments may include more than one memory module.

The parking notification system 100 comprises a display 236 for providing visual output such as, for example, parking information, maps, navigation, entertainment, information, or a combination thereof. The display 236 is coupled to the communication path 220. Accordingly, the communication path 220 communicatively couples the display 236 to other modules of the parking notification system 100. The display 236 may include any medium capable of transmitting an optical output such as, for example, a cathode ray tube, light emitting diodes, a liquid crystal display, a plasma display, or the like. Moreover, the display 236 may be a touchscreen that, in addition to providing optical information, detects the presence and location of a tactile input upon a surface of or adjacent to the display 236. Accordingly, each display 236 may receive a mechanical input directly upon the optical output provided by the display 236. Additionally, it is noted that the display 236 can include at least one of the one or more processors 232 and one or more non-transitory computer readable memory 234. While the parking notification system 100 includes a display 236 in the embodiment depicted in FIG. 2, the parking notification system 100 may not include a display 236 in other embodiments.

Still referring to FIG. 2, an occupant sensor 238 may be any device or combination of components capable of outputting an occupant sensor signal indicative of the presence or absence of an occupant in the vehicle 110. The occupant sensor 238 may comprise a single pressure sensor provided on each vehicle seat. The occupant sensor 238 may also comprise an array of sensors including, but not limited to, a camera, a motion sensor, a strain gauge, a pressure sensor, a microphone, a heat sensor, a contact sensor and seat belt restraint sensor to determine the presence or absence of an unattended occupant. The occupant sensor 238 may comprise one or more sensor signals when provided to the controller 230 to determine the presence or absence of an occupant. The occupant sensor 238 is communicatively coupled to the controller 230 providing at least one occupant sensor signal for determining the presence or absence of an occupant in the vehicle 110.

Still referring to FIG. 2, one or more input devices 240 are coupled to the communication path 220 and communicatively coupled to the processor 232. The input device 240 may be any device capable of transforming user contact into a data signal that can be transmitted over the communication path 220 such as, for example, a button, a switch, a knob, a microphone or the like. In some embodiments, the input device 240 includes a power button, a volume button, an activation button, a scroll button, or the like. The one or more input devices 240 may be provided so that the user may interact with the display 236, such as to navigate menus, make selections, set preferences, and other functionality described herein. In some embodiments, the input device 240 includes a pressure sensor, a touch-sensitive region, a pressure strip, or the like. It should be understood that some embodiments may not include the input device 240.

The speaker 242 (i.e., an audio output device) is coupled to the communication path 220 and communicatively coupled to the processor 232. The speaker 242 transforms audio message data from the processor 232 of the controller 230 into mechanical vibrations producing sound. For example, the speaker 242 may provide to the driver the parking information determined by the parking notification system 100 and request confirmation of the validity of the parking information as determined by the controller 230 from the image data of the one or more cameras 246, and the like when the controller 230 determines the vehicle 110 is parked. However, it should be understood that, in other embodiments, the parking notification system 100 may not include the speaker 242.

The microphone 244 is coupled to the communication path 220 and communicatively coupled to the processor 232. The microphone 244 may be any device capable of transforming a mechanical vibration associated with sound into an electrical signal indicative of the sound. The microphone 244 may be used as an input device 240 to perform tasks, such as confirming the validity of the parking information before exiting the vehicle 110, navigating menus, inputting settings and parameters, and any other tasks. It should be understood that some embodiments may not include the microphone 244.

Still referring to FIG. 2, the first camera 246 and the second camera 247 are coupled to the communication path 220 and communicatively coupled to the processor 232. Each of the first camera 246 and the second camera 247 may be any device having an array of sensing devices (e.g., pixels) capable of detecting radiation in an ultraviolet wavelength band, a visible light wavelength band, or an infrared wavelength band. Each of the first camera 246 and the second camera 247 may have any resolution. Each of the first camera 246 and the second camera 247 may be an omni-directional camera, or a panoramic camera. In some embodiments, one or more optical components, such as a mirror, fish-eye lens, or any other type of lens may be optically coupled to each of the first camera 246 and the second camera 247. One or more cameras may be positioned on the vehicle 110 to capture images of the surroundings of the vehicle 110 during operation.

For example, the first camera 246 may be positioned on the dash of the vehicle 110 to capture sightlines similar to those of the driver. In other embodiments, one or more cameras may be positioned above the windshield to capture surroundings generally in front of a vehicle 110. Additionally, one or more cameras may be positioned on the sides and rear of the vehicle 110 to view surroundings of a vehicle 110 along the sides and rear of the vehicle 110. The positioning of the one or more cameras allows for capture of image data that may include location specific information such as landmarks, street signs, street names, street addresses, building architecture, structure signs, or the like. Positioning of the one or more cameras on the front, side, rear and/or roof portion of the vehicle 110 may further facilitate capture of image data that includes images of parking signs, parking level signs, parking space markings or the like.

The image data may be received by the processor 232, which may process the image data using one or more algorithms. Any known or yet-to-be developed optical character recognition algorithms may be applied to the image data in order to recognize text included in the image data. One or more object recognition algorithms may be applied to the image data to extract objects. Any known or yet-to-be-developed object recognition algorithms may be used to extract the objects from the image data. Example object recognition algorithms include, but are not limited to, scale-invariant feature transform (“SIFT”), speeded up robust features (“SURF”), and edge-detection algorithms. Any known or yet-to-be developed architecture recognition algorithms may also be applied to the image data to detect particular buildings within the environment. These methods may be similar to known or yet-to-be developed facial recognition algorithms applied to image data to detect and determine a person within the environment. The optical character recognition algorithms, object recognition algorithms, or facial recognition algorithms may be stored in the non-transitory computer readable memory 234 and executed by the processor 232.

The network interface hardware 260 is coupled to the communication path 220 and communicatively coupled to the processor 232. The network interface hardware 260 may be any device capable of transmitting and/or receiving data via a network 270. Accordingly, network interface hardware 260 can include a communication transceiver for sending and/or receiving any wired or wireless communication. For example, the network interface hardware 260 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 260 includes hardware configured to operate in accordance with the Bluetooth wireless communication protocol. In another embodiment, network interface hardware 260 may include a Bluetooth send/receive module for sending and receiving Bluetooth communications to/from a portable electronic device 280. The network interface hardware 260 may also include a radio frequency identification (“RFID”) reader configured to interrogate and read RFID tags.

Still referring to FIG. 2, a global positioning system, (GPS) 248, is coupled to the communication path 220 and communicatively coupled to the controller 230. The GPS 248 is capable of generating location information indicative of a location of the vehicle 110. The GPS signal communicated to the controller 230 via the communication path 220 may include location information comprising a NMEA message, a latitude and longitude data set, a street address, a name of a known location based on a location database, or the like. Additionally, the GPS 248 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas.

A tachometer 250 may be coupled to the communication path 220 and communicatively coupled to the controller 230. The tachometer 250 may be any device capable of generating a signal indicative of a rotation speed of a shaft as in a vehicle 110 engine or a drive shaft. Tachometer signals are communicated to the processor 232 and converted a speed value. The speed value in some embodiments is indicative of the speed of the vehicle 110. In some embodiments, the tachometer 250 comprises an opto-isolator slotted disk sensor, a Hall Effect sensor, a Doppler radar, or the like. The tachometer 250 may be provided so that the controller 230 may determine when the vehicle 110 is parked or when the vehicle 110 is approaching a parking location 120. It should be understood that some embodiments may not include the tachometer 250.

The parking notification system 100 of FIG. 2, may further include an ignition sensor 252 that is coupled to the communication path 220 and communicatively coupled to the controller 230. The ignition sensor 252 generates a signal indicative of the operational state of the vehicle 110. The ignition sensor 252 may be any sensor capable of determining engine ON/OFF, such as any one or more, without limitation, an oil pressure sensor, a fuel pressure sensor, a crankshaft position sensor, a camshaft position sensor, a spark plug operation sensor, a battery voltage sensor, or the like. The ignition sensor 252 may be provided so that the controller 230 may determine when the vehicle 110 is parked and/or the driver has exited the vehicle 110. It should be understood that some embodiments may not include the ignition sensor 252.

In some embodiments, the parking notification system 100 may be communicatively coupled to a portable electronic device 280 via the network 270. In some embodiments, the network 270 is a personal area network that utilizes Bluetooth technology to communicatively couple the parking notification system 100 and the portable electronic device 280. In other embodiments, the network 270 may include one or more computer networks (e.g., a personal area network, a local area network, or a wide area network), cellular networks, satellite networks and/or a global positioning system and combinations thereof. Accordingly, the parking notification system 100 can be communicatively coupled to the network 270 via wires, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 2, as stated above, the network 270 may be utilized to communicatively couple the parking notification system 100 with the portable electronic device 280. The portable electronic device 280 may include a mobile phone, a smartphone, a personal digital assistant, a camera, a dedicated mobile media player, a mobile personal computer, a laptop computer, and/or any other portable electronic device 280 capable of being communicatively coupled with the parking notification system 100. The portable electronic device 280 may include one or more processors 232 and one or more non-transitory computer readable memories 234. The one or more processors 232 can execute the machine-readable instruction set to communicate with the parking notification system 100. The portable electronic device 280 may be configured with wired and/or wireless communication functionality for communicating with the parking notification system 100. In some embodiments, the portable electronic device 280 may perform one or more elements of the functionality described herein, such as, in embodiments in which the functionality described herein is distributed between the parking notification system 100 and the portable electronic device 280.

In an embodiment of the parking notification system 100 for identifying the location of a vehicle 110, the parking notification system 100 comprises a controller 230 having a processor 232 and a non-transitory computer readable memory 234. The controller 230 receives signals comprising image data from the first camera 246 and/or the second camera 247 and the processor 232 executes a machine-readable instruction set to automatically determine whether a vehicle 110 has entered a parking location 120 from the image data. The controller 230 further determines parking information from the image data and automatically communicates the parking information (e.g. to a driver). A parking location 120 and parking information may comprise of general and specific information regarding where the vehicle 110 is parked. A parking location 120 may be a parking area, such as, a parking lot, a street with street side parking, a parking structure, a residential garage, a parking space, or the like. Parking information may include details regarding where the parking location 120 is located and more specifically information about where the vehicle 110 is located within the parking location 120. As a non-limiting example, parking information may include a street address for the parking garage identified through the image data provided by at least one of the first camera 246 and the second camera 247 as well as a parking level indicator 124 and parking space marker 122 identified through the image data provided by at least one of the first camera 246 and the second camera 247 that further defines where the vehicle 110 is parked within the parking garage.

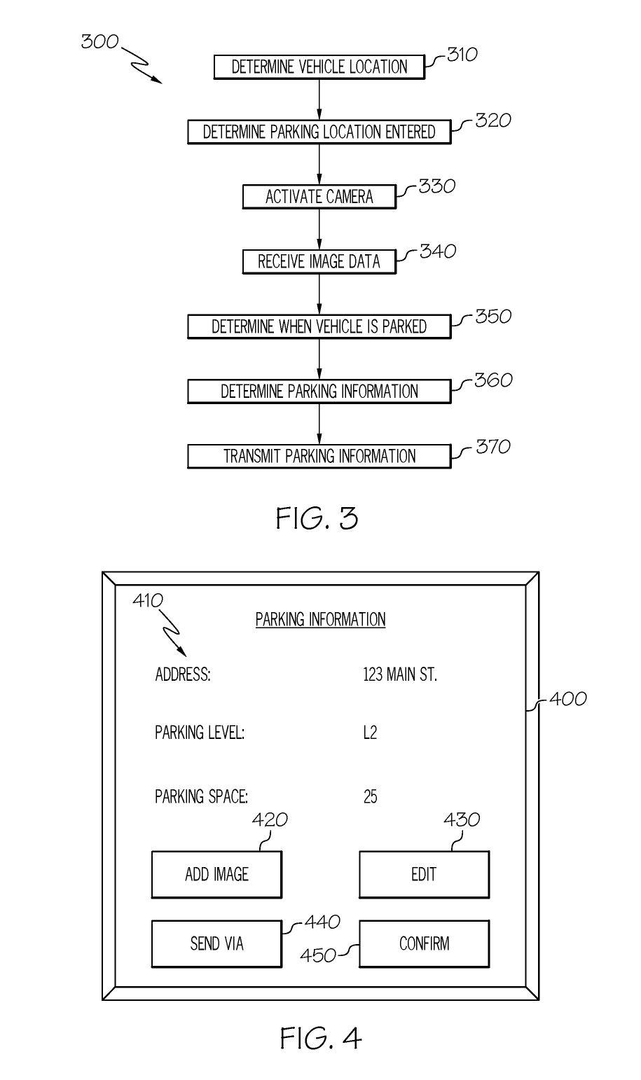

The following sections will now describe embodiments of the operation of the parking notification system 100 for identifying the location of a vehicle 110. Referring now to FIG. 3, a flowchart of an example embodiment of a method for a parking notification system 100 for identifying the location of a vehicle 110 is depicted. The flowchart depicted in FIG. 3 is a representation of a machine-readable instruction set stored in the non-transitory computer readable memory 234 and executed by the processor 232 of the controller 230. The process of the flowchart in FIG. 3 may be executed at various times and in response to signals from the sensors communicatively coupled to the controller 230.

In step 310, the controller 230 determines the location of the vehicle 110. The controller 230 may determine the location of the vehicle 110 from location information provided by the GPS 248. In some embodiments, there may not be a GPS 248 communicatively coupled to the controller 230. In such embodiments, location information may be determined based on image data provided by at least one of the first camera 246 and the second camera 247 to the controller 230. The location of the vehicle 110 is continuously updated by either the image data received from at least one of the first camera 246 and the second camera 247 or the GPS 248. In many parking structures, signals to the GPS 248 are unable to penetrate the parking structure or may be reflected or distorted by surrounding buildings. In order to provide parking location information when either the GPS 248 is unreliable or unavailable, image data from the first camera 246 and/or the second camera 247 may be acquired and processed by the controller 230 to determine the location of the vehicle 110. The determination may include acquiring and processing image data containing image artifacts of buildings, landmarks, street signs, or the like.

In step 320, the parking notification system may also determine when the vehicle enters a parking location. In some embodiments, for example, a GPS 248 providing location information to the controller 230 may indicate the vehicle 110 has entered a known parking location 120 thus triggering at least one of the first camera 246 and the second camera 247 to begin capturing and transmitting image data to the controller 230. As a non-limiting example, the controller 230 or GPS 248 may be configured to determine that a vehicle has entered a parking location by comparing the location information with a location database stored in communicatively coupled non-transitory computer readable memory 234. In other embodiments, the determination that a vehicle has entered a parking location may be determined from image data received from at least one of the first camera 246 and the second camera 247.

In step 330, of FIG. 3, the parking notification system 100 activates at least one of the first camera 246 and the second camera 247 in response to determining the vehicle 110 has entered a parking area. In some embodiments, at least one of the first camera 246 and the second camera 247 is activated to capture image data once the vehicle 110 enters a parking location 120. In some embodiments, the activation of the camera is automatic in response to the controller 230 receiving a signal indicative of a parking location. In other embodiments, the controller determines the vehicle 110 is in a parking location in response to the GPS providing location information indicative of a parking location 120.

In step 340, of FIG. 3, the parking notification system 100 receives image data from at least one of the first camera 246 and the second camera 247 positioned on the vehicle 110 and communicatively coupled to the controller 230 via the communication path 220. There may be one or more cameras positioned on the vehicle 110 to produce image data of the surroundings of the vehicle 110. At least one of the first camera 246 and the second camera 247 may continuously transmit image data to the controller 230. In other embodiments, a sensor signal from a sensor communicatively coupled to the controller 230 may trigger at least one of the first camera 246 and the second camera 247 to capture and transmit image data to the controller 230.

In some embodiments, a driver may initiate collection of image data by the parking notification system 100 through an input signal received from the driver. The driver may provide a signal to start the camera 246 of the parking notification system 100 through a key fob communicatively coupled to the network interface hardware 260. In other embodiments, the driver may provide an input in an application on a portable electronic device 280 communicatively coupled to the network interface hardware 260. In yet other embodiments, the camera 246 may activate and send image data to the controller 230 when the vehicle 110 is turned on (e.g. by receiving a signal from the ignition sensor 252).

In step 350, the controller 230 determines when the vehicle 110 is parked. Determining when the vehicle 110 is parked may be determined from a variety of events captured by sensors that provide indicative signals to the controller 230. As a non-limiting example, an ignition sensor 252 may generate a signal indicative of the operational state of the vehicle 110. The ignition sensor 252 may be a sensor monitoring the presence or absence of a key in the ignition. For example, when a key is removed from the ignition the ignition sensor 252 may generate a signal indicative of the absence of the key where the signal is received by the controller 230 indicating the vehicle 110 is off and thus parked. In other embodiments, the ignition sensor 252 may be any sensor capable of generating a signal indicative of the state of the engine (ON/OFF), such as any one or more, without limitation, an oil pressure sensor, a fuel pressure sensor, a crankshaft position sensor, a camshaft position sensor, a spark plug operation sensor, a battery voltage sensor, or the like.

In another embodiment, image data from at least one of the first camera 246 and the second camera 247 may indicate the vehicle 110 is no longer moving or is positioned in a parking structure in such a way that is indicative of a parked vehicle 110. For example, the controller 230 may be configured to conclude that image data comprising a view of yellow lines on opposite sides of the vehicle 110 and a numbered space behind the vehicle 110 indicates the vehicle 110 is parked. In yet other embodiments, a tachometer 250 may indicate the vehicle 110 is no longer in motion thus indicating the vehicle 110 is parked. These embodiments are merely examples; other embodiments for determining when a vehicle 110 is parked may be implemented.

In step 360, once the controller 230 determines the vehicle 110 is parked, from step 350, the controller 230 determines parking information. Parking information may be determined from image data comprising images of parking level indicators, parking space markers, or unique features of the parking structure. Parking information may also be determined from image data comprising images of street addresses, landmarks, or the like. Once parking information is determined in step 360, the parking information may be converted to a user-friendly format and transmitted. In some embodiments, the controller 230 may convert image data to text data for communication to a driver. For example, image data including an image of a parking level indicator 124 comprising the notation “L2” as depicted in FIG. 1 may be converted to text data format “L2” and communicated to the driver.

In step 370, the parking information is transmitted. In some embodiments, the transmission of the parking information in step 370 may be to a network 270. The controller 230 may generate a signal indicative of the parking information and transmit the signal to network interface hardware 260. The network interface hardware 260 may in turn transmit the signal to the network 270. The network 270 may further relay the signal to a portable electronic device 280. In other embodiments, the transmission of the parking information determined in step 360 may be directly transmitted to a portable electronic device 280. The controller 230 may generate a signal indicative of the parking information and transmit the signal to network interface hardware 260. The network interface hardware 260 may transmit the signal directly to a portable electronic device 280, for example, over a WiFi or Bluetooth connection (e.g. in the form of an E-mail).

Step 370, may also include transmitting the parking information to a display 236. The display 236 may be communicatively coupled to the controller 230. The parking information may be provided to the display 236 for confirmation of the parking information from the driver. The driver may be prompted to confirm the parking information before exiting the vehicle 110. In the event the driver does not confirm the parking information before exiting or turning off the vehicle 110, the controller 230 may automatically transmit the parking information via the network interface hardware 260.

In some embodiments, the driver exiting the vehicle 110 may trigger transmission of the parking information, in step 370. An occupant sensor 238, such as a weight sensor positioned on the vehicle seat provides a signal indicative of the presence or absence of an occupant to the controller 230, which may be used to trigger the transmission of the parking information. A signal indicative of the absence of a driver may indicate the driver has exited the vehicle 110. In other embodiments, an occupant sensor 238 comprising a camera configured to detect the presence of an occupant (e.g. the driver) may trigger the transmission of the parking information. In yet other embodiments, any sensor indicating the driver exited the vehicle 110 may trigger the transmission of the parking information.

In some embodiments, in step 370, the display 236 may provide the parking information to a driver for confirmation. The confirmation process may include an option for the driver to edit the parking information or provide additional details to the parking information such as an image of the parking structure previously captured by one or more of the first camera 246 and the second camera 247. In such embodiments, the controller 230 provides the driver with the ability to customize the parking information. The parking information may later be transmitted in the form that was updated and/or confirmed by the driver.

Referring to FIG. 4, an example display 400 (e.g., the display 236 of FIG. 2) including a confirmation screen for confirming the parking information 410 is depicted. The parking notification system 100 may display the parking information 410 on a display 400 once the vehicle 110 is parked so the driver may customize and/or confirm the parking information 410. The display 400 includes the parking information 410, and input controls 420, 430, 440, and 450. The input controls 420, 430, 440, and 450 may be a mechanical button or a touch-sensitive region of the display 236. In FIG. 4, input control 420, “Add Image,” may provide the ability for an image to be attached to the parking information 410. Input control 430, “Edit”, may provide the capability to correct or change the parking information 410 presented on the display 400. Input control 440, “Send Via,” may provide the ability to select the mode of transmission that is used to send the parking information 410 to the driver. Input control 440, may also provide the ability to select the format the parking information may be received. As non-limiting examples, the parking information may be sent as a text message, a push notification, an email, a data packet to an application, or the like. Input control 440, may also provide the ability to change the destination to which the parking information 410 is sent. As non-limiting examples, the destination defined by an email address, a phone number, a user name of an application, or the like. Input control 450, “Confirm,” may offer the ability to confirm the parking information 410. While FIG. 4 includes four input controls 420, 430, 440, and 450, more or less may be implemented in other embodiments. Similarly, the input controls 240, 420, 430, 440, or 450 may offer additional functionality to customize the parking notification system 100.

In some embodiments, the controller 230 may provide an auditory recitation of the parking information 410 via a speaker 242. The controller 230 may also request an auditory confirmation of the parking information 410 from the driver. The driver may confirm the parking information 410 through a voice response captured by the microphone 244.

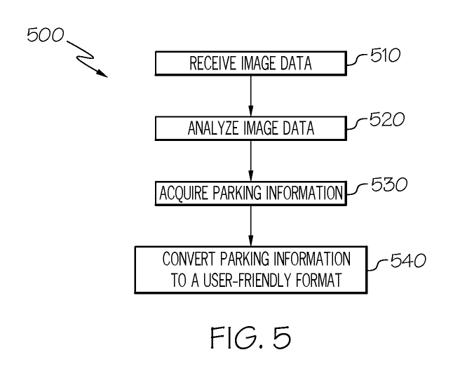

Referring to FIG. 5, a flowchart of an example embodiment of an image processing method 500 of the parking notification system 100 for identifying the location of a vehicle 110 is depicted. The flowchart in FIG. 5 is intended to show an exemplary conversion of image data captured by one or more of the first camera 246 and the second camera 247 to user-friendly parking information 410 for transmission to a driver. The controller 230, in step 510, receives image data. The image data may be received directly from one or more of the first camera 246 and the second camera 247 or pre-processed by an image processor 232 before being transmitted to and received by the controller 230. Additionally, the image processing may occur within an image-processing controller having a separate processor 232 and non-transitory computer readable memory 234 communicatively coupled to the controller 230.

Once the image data is received, the image data is analyzed in step 520. Analyzing image data may comprise pre-processing, character and/or feature recognition and post-processing steps. As a non-limiting example, during pre-processing an image may be reviewed to reduce noise in the image data, enhance contrast, apply scale-spacing to address variations in sizes between real-world objects and image data of the real-world object, or the like. Further, as a non-limiting example, character and/or feature recognition of image data may comprise applying pattern matching algorithms, image correlation algorithms or the like. Additionally, as a non-limiting example, post-processing of image data may comprise filtering the converted image data through a lexicon of allowed terms or characters, associating the converted image data with known locations or representative images, or the like. Step 520 may generate converted image data for further filtering and extraction of relevant parking information 410 by step 530.

In step 530, the controller 230 receives the processed and converted image data from step 520. In step 530, the image data is further filtered for relevant parking information 410. The image data may include recognized text and images, which include information other than parking information 410. For example, image data received in step 530 may include recognized text from an advertisement in a parking structure, from exit signs or traffic signs, from parking level indicators 124, from parking space markers 122, or the like. Step 530 filters and searches the image data from step 520 and extracts portions that represent parking information 410. For example, step 530 may comprise applying an algorithm that determines a portion of the converted image data represents a parking level indicator 124 based on the location of the parking level indicator 124 and the content of the sign. As another example, step 530 may comprise applying an algorithm that determines a portion of the converted image data represents a parking space marker 122 because one or more of the first camera 246 and the second camera 247 in which the image data was captured from was a camera positioned to view below and behind a vehicle 110, the location where parking space markers are generally located. Various algorithms may be implemented by one skilled in the art to further determine parking information 410 from the converted image data.

In step 540, the parking information 410 acquired from step 530 is formatted into a user-friendly format. For example, parking information 410, such as a parking space number may be labeled as a parking space number. As another example, the parking information 410 may be formatted for display on a portable electronic device 280 or a display 400 as depicted, for example, in FIG. 4. In some embodiments, the parking information 410 may be integrated into a mapping application viewable by a portable electronic device 280.

The image processing method 500 depicted in FIG. 5 is only one example of an image processing method 500, other image processing methods may be implemented to determine parking information 410 from image data. Additionally, the method depicted in FIG. 5 may be applied at any time during the operation of the parking notification system 100. The parking notification system 100 may utilize the same or a similar method as depicted in FIG. 5 to determine the location of a vehicle 110, when a vehicle 110 is parked, or where the vehicle 110 is parked.

It should now be understood that embodiments described herein are directed to parking notification systems that identify locations of vehicles by receiving image data from cameras positioned on the vehicles to view the surroundings of the vehicles, determine the location of the vehicle and parking information from the image data, and automatically transmit the parking information obtained by the system. The parking notification system comprises at least a controller enabled to receive image data from a camera automatically when the system determines that the vehicle has entered a parking location. The parking notification system may optionally receive to the controller various signals from sensors in the vehicle to more completely determine the location of the vehicle and whether the vehicle is parked.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A parking notification system for identifying a location of a vehicle, the parking notification system comprising:
a controller comprising a processor and a non-transitory computer readable memory;
a camera communicatively coupled to the controller, wherein the camera automatically captures image data and transmits the image data to the controller;
a machine-readable instruction set stored in the non-transitory computer readable memory that causes the parking notification system to perform at least the following when executed by the processor:
determine when the vehicle enters a parking area;
activate the camera in response to determining that the vehicle has entered the parking area;
receive the image data from the camera once activated;
determine when the vehicle is parked;
determine parking information from the image data; and
transmit the parking information automatically to an output of the controller in response to determining that the vehicle is parked.

2. The parking notification system of claim 1, further comprising a global positioning system communicatively coupled to the controller, wherein the global positioning system provides location information to the controller for determining when the vehicle enters the parking area.

3. The parking notification system of claim 2, wherein the machine-readable instruction set further causes the processor to store at least one of: the image data, the location information, and the parking information in the non-transitory computer readable memory.

4. The parking notification system of claim 1, wherein the output of the controller is communicatively coupled to a wireless communication module configured to wirelessly transmit the parking information, and the machine-readable instruction set further causes the processor to provide the parking information to the wireless communication module for wireless transmission.

5. The parking notification system of claim 1, wherein the output of the controller is communicatively coupled to a display module configured to display the parking information on the display module, and the machine-readable instruction set further causes the processor to provide the parking information to the display module.

6. The parking notification system of claim 5, wherein the machine-readable instruction set further causes the processor to request confirmation of the parking information on the display module.

7. The parking notification system of claim 1, further comprising a vehicle speed sensor communicatively coupled to the controller, wherein the vehicle speed sensor provides a vehicle speed signal to the processor, and the machine-readable instruction set further causes the processor to determine the vehicle has entered the parking area when the vehicle speed signal is below a threshold speed value.

8. The parking notification system of claim 1, further comprising a vehicle speed sensor communicatively coupled to the controller, wherein the vehicle speed sensor provides a vehicle speed signal to the processor, and the machine-readable instruction set further causes the processor to determine the vehicle is parked when the vehicle speed signal is below a threshold speed value.

9. The parking notification system of claim 1, further comprising an occupant sensor communicatively coupled to the controller for determining when the vehicle is parked, wherein the occupant sensor provides an occupant sensor signal indicative of a presence or an absence of a driver to the processor.

10. The parking notification system of claim 9, wherein the occupant sensor is a weight sensor positioned within a driver seat for determining the presence of the driver in the vehicle.

11. A method for locating a parked vehicle, comprising:
determining a vehicle entered a parking area;
activating a camera in response to determining that the vehicle has entered the parking area;
receiving image data from the camera once activated;
determining parking information from the image data;
determining when the vehicle is parked; and
transmitting the parking information automatically in response to determining that the vehicle is parked.

12. The method of claim 11, further comprising determining a vehicle location from the image data wherein the image data is received by the camera.

13. The method of claim 11, wherein the parking information is obtained from a global positioning system.

14. The method of claim 11, further comprising displaying the parking information on a display within the vehicle when the vehicle is parked.

15. The method of claim 11, wherein determining the parking information from the image data comprises processing the image data with an image recognition system, wherein the image recognition system is configured to analyze the image data, acquire the parking information from the image data, and provide the parking information in a readable format.

16. The method of claim 11, wherein transmitting the parking information comprises transmitting an email comprising the parking information.

17. The method of claim 11, wherein transmitting the parking information comprises providing the parking information to a parking application accessible by a portable electronic device.

18. The method of claim 11, wherein transmitting the parking information is triggered by a signal from an input device.

19. The method of claim 11, wherein transmitting the parking information is triggered automatically upon determining the parking information from the image data.

20. A parking notification system for identifying a location of a vehicle, the parking notification system comprising:
a controller comprising a processor and a non-transitory computer readable memory;
a camera communicatively coupled to the controller, wherein the camera is configured to capture image data and transmit the image data to the controller;
a global positioning system communicatively coupled to the controller, wherein the global positioning system provides location information to the controller;
a wireless communication module configured to wirelessly transmit information, wherein the wireless communication module is communicatively coupled to the processor;
an occupant sensor communicatively coupled to the controller, wherein the occupant sensor provides an occupant sensor signal indicative of a presence or an absence of a driver to the processor; and
a machine-readable instruction set stored in the non-transitory computer readable memory that causes the parking notification system to perform at least the following when executed by the processor:
determine when the vehicle enters a parking area based at least in part on the location information;
activate the camera in response to determining that the vehicle has entered the parking area;
receive the image data from the camera once activated;
determine when the vehicle is parked based on at least one of the image data captured by the camera and the location information provided by the global positioning system;
determine parking information from the image data;
determine the presence of the driver in the vehicle based on the occupant sensor signal; and
transmit the parking information with the wireless communication module in response to the occupant sensor signal.
